(19) United States
(12) Patent Application Publication
(10) Pub. No.: US 2026/0144190 A1
(43) Pub. Date: May 28, 2026

(54) Saffron Stem Extractor Device

(71) Applicant: Robert Sarda, Cumming, GA (US)

(72) Inventor: Robert Sarda, Cumming, GA (US)

(21) Appl. No.: 19/286,977

(22) Filed: Jul. 31, 2025

Related U.S. Application Data
(60) Provisional application No. 63/725,559, filed on Nov. 27, 2024.

(51) Int. Cl. A01D 46/00

(52) U.S. Cl. CPC A01D 46/00

(57) ABSTRACT

A saffron stem extractor device is provided. The device is comprised of a saffron stem extractor device designed to facilitate the harvesting of saffron stems from crocus flowers while the flowers remain attached to their bulbs. The device comprises a cutting mechanism configured to sever saffron stems with minimal disruption, wherein the cutting mechanism may include a laser system directed by at least one redirecting element such as a mirror or optical scanner, or a mechanical blade system adapted to various cutting geometries. A vacuum tube composed of a transparent material is used to encase the saffron stems prior to cutting, while a vacuum motor generates negative pressure to extract the severed threads into a collection chamber. A viewing element such as a digital camera or optical magnifier is included for precise visual targeting and is wirelessly linked to a smart device mounted to the apparatus for real-time imaging feedback.

### CROSS REFERENCE TO RELATED APPLICATION

The present application claims priority to, and the benefit of, U.S. Provisional Application No. 63/725,559, which was filed on Nov. 27, 2024, and is incorporated herein by reference in its entirety.

### FIELD OF THE INVENTION

The present invention relates generally to the field of saffron harvesting. More specifically, the present invention relates to a device designed to facilitate the harvesting of saffron stems from crocus flowers while the flowers remain attached to their bulbs. Accordingly, the present disclosure makes specific reference thereto. Nonetheless, it is to be appreciated that aspects of the present invention are also equally applicable to other like applications, devices, and methods of manufacture.

### BACKGROUND

The harvesting of saffron from crocus flowers remains a labor-intensive and time-sensitive agricultural process, as saffron is derived from the stigmas of the crocus flower, which must be collected at a specific time to ensure optimum quality and yield. Traditional methods involve manually plucking the entire flower from its bulb, then separating the saffron threads at a dedicated station. This approach not only introduces the risk of damaging the plant and reducing future yields but also requires workers to spend prolonged periods bending over in the field. Such repetitive physical activity can lead to discomfort, fatigue, and long-term ergonomic strain. Furthermore, the timing and precision required in separating the delicate saffron threads present additional challenges. If flowers are harvested too early or too late, the saffron quality may diminish significantly. There is also inconsistency in manual processing, resulting in variable thread quality and potential contamination. These operational inefficiencies underscore the need for a specialized solution that can extract saffron stems with precision, speed, and minimal physical exertion.

Therefore, there exists a long-felt need in the art for a saffron stem extractor device that enables precise severing and collection of saffron threads directly from crocus flowers without removing the entire flower. There also exists a long-felt need in the art for a saffron stem extractor device that reduces physical strain on users by eliminating the need to bend over repeatedly during harvesting. Moreover, there exists a long-felt need in the art for a saffron stem extractor device that integrates real-time visual guidance and automation to ensure accurate targeting and efficient extraction of saffron stems.

The subject matter disclosed and claimed herein, in one embodiment thereof, comprises a saffron stem extractor device. The device is comprised of a saffron stem extractor device designed to facilitate the harvesting of saffron stems from crocus flowers while the flowers remain attached to their bulbs. The device comprises a cutting mechanism configured to sever saffron stems with minimal disruption, wherein the cutting mechanism may include a laser system directed by at least one redirecting element such as a mirror or optical scanner, or a mechanical blade system adapted to various cutting geometries. A vacuum tube composed of a transparent material is used to encase the saffron stems prior to cutting, while a vacuum motor generates negative pressure to extract the severed threads into a collection chamber. The collection chamber is fabricated from food-grade materials and sealed using a secure locking lid. A viewing element such as a digital camera or optical magnifier is included for precise visual targeting and is wirelessly linked to a smart device mounted to the apparatus for real-time imaging feedback.

In this manner, the saffron stem extractor device of the present invention accomplishes all the foregoing objectives and provides a device that enables targeted extraction of saffron threads directly from crocus flowers without removing the entire bloom, thereby preserving plant integrity and enhancing harvesting efficiency. The ergonomic handle and integrated suction mechanism further allows users to operate the device without prolonged bending, significantly reducing physical fatigue. The inclusion of real-time visual guidance through wireless imaging additionally facilitates precise alignment of the cutting mechanism, ensuring consistent quality and minimal waste. By integrating automated cutting, suction, and collection into a single handheld unit, the device addresses the inefficiencies, ergonomic concerns, and variability associated with manual saffron harvesting practices.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a saffron stem extractor device. The device is designed to efficiently sever and collect saffron stems directly from crocus flowers without detaching the flowers from their natural environment. The device is comprised of integrated components configured to perform cutting, viewing, suction, and collection functions in a coordinated manner.

The device is comprised of a cutting mechanism configured to separate saffron stems with precision and minimal disturbance. The cutting mechanism may be comprised of a laser source directed by at least one redirecting element, such as a stationary or rotating mirror, a galvanometer-based scanner, or a prism-based deflector. Alternatively, or additionally, the cutting mechanism is comprised of at least one mechanically actuated blade. Activation of the cutting mechanism is controlled by at least one user interface control.

The device is further comprised of a viewing element, such as a digital microscope, optical magnifier, or camera module. The viewing element transmits visual data wirelessly using a communication module to a smart device, such as a smartphone.

The device is further comprised of a vacuum tube configured for insertion into the flower to secure the saffron stem. A vacuum motor further generates negative pressure to draw the severed stem into a collection chamber. The collection chamber is comprised of food-grade material and includes a lid secured by a locking mechanism to prevent contamination and material loss. The device is further comprised of an ergonomic handle featuring an anatomical contour and a grip area made of non-slip material. The grip area incorporates surface texture for improved tactile feedback and stability.

A method of use is also disclosed. The device is first provided with all functional components. The user then grasps the handle to insert the vacuum tube into the flower to position the saffron stem. The viewing element is then used to align the cutting mechanism while real-time imagery is displayed. The user then activates the cutting mechanism, which is directed by the redirecting element. The vacuum motor is further engaged to extract the severed stem into the collection chamber.

Accordingly, the saffron stem extractor device of the present invention is particularly advantageous as it provides a device that enables targeted extraction of saffron threads directly from crocus flowers without removing the entire bloom, thereby preserving plant integrity and enhancing harvesting efficiency. The ergonomic handle and integrated suction mechanism further allows users to operate the device without prolonged bending, significantly reducing physical fatigue. The inclusion of real-time visual guidance through wireless imaging additionally facilitates precise alignment of the cutting mechanism, ensuring consistent quality and minimal waste. By integrating automated cutting, suction, and collection into a single handheld unit, the device addresses the inefficiencies, ergonomic concerns, and variability associated with manual saffron harvesting practices and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a saffron stem extractor device of the present invention in accordance with the disclosed architecture;

FIG. 2 illustrates an enhanced perspective view of one end of one potential embodiment of a saffron stem extractor device of the present invention in accordance with the disclosed architecture;

FIG. 3 illustrates an enhanced perspective view of one end of one potential embodiment of a saffron stem extractor device of the present invention in accordance with the disclosed architecture; and

FIG. 4 illustrates a flowchart of a method of using one potential embodiment of a saffron stem extractor device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a saffron stem extractor device that enables precise severing and collection of saffron threads directly from crocus flowers without removing the entire flower. There also exists a long-felt need in the art for a saffron stem extractor device that reduces physical strain on users by eliminating the need to bend over repeatedly during harvesting. Moreover, there exists a long-felt need in the art for a saffron stem extractor device that integrates real-time visual guidance and automation to ensure accurate targeting and efficient extraction of saffron stems.

The present invention, in one exemplary embodiment, is comprised of a saffron stem extractor device. The device enables efficient severing and collection of saffron stems directly from crocus flowers while maintaining the flowers in their natural growing environment. More specifically, the device is configured to perform cutting, viewing, suction, and collection operations in a coordinated and streamlined manner.

A cutting mechanism is configured to remove saffron stems with precision and minimal disruption. The cutting mechanism may incorporate a laser source guided by at least one redirecting element, such as a stationary mirror, rotating mirror, galvanometer-based scanner, or prism-based beam deflector. In an alternative or additional configuration, the cutting mechanism may include at least one mechanically actuated blade. Operation of the cutting mechanism is controlled through at least one user interface control.

A viewing element, such as a digital microscope, optical magnifier, or camera module, is also included. The viewing element wirelessly transmits visual data through a communication module to a smart device, such as a smartphone, enabling real-time feedback.

The device includes a vacuum tube configured for insertion into a flower to position and secure the saffron stem. A vacuum motor generates negative pressure to draw the severed stem into a collection chamber. The collection chamber is fabricated from food-grade material and includes a lid secured by a locking mechanism to prevent contamination and loss of material. An ergonomic handle with anatomical contouring is provided, along with a non-slip grip area that incorporates surface texture to enhance tactile feedback and operational stability.

A method of operation is also provided. The device is first provided with all necessary functional components. The user then grips the handle and inserts the vacuum tube into the flower to position the saffron stem. Alignment of the cutting mechanism is achieved using the viewing element while real-time imagery is displayed. The cutting mechanism is then activated, guided by the redirecting element, and the vacuum motor is engaged to transfer the severed stem into the collection chamber.

As a result, the device provides an efficient solution for the targeted harvesting of saffron threads directly from crocus flowers while preserving the integrity of the plant. The ergonomic handle and integrated suction system further reduce the need for prolonged bending, minimizing physical strain. Wireless visual feedback enhances the accuracy of cutting alignment. As a result, the integration of automated cutting, suction, and collection into a single handheld device offers a practical improvement over conventional manual saffron harvesting methods and tools.

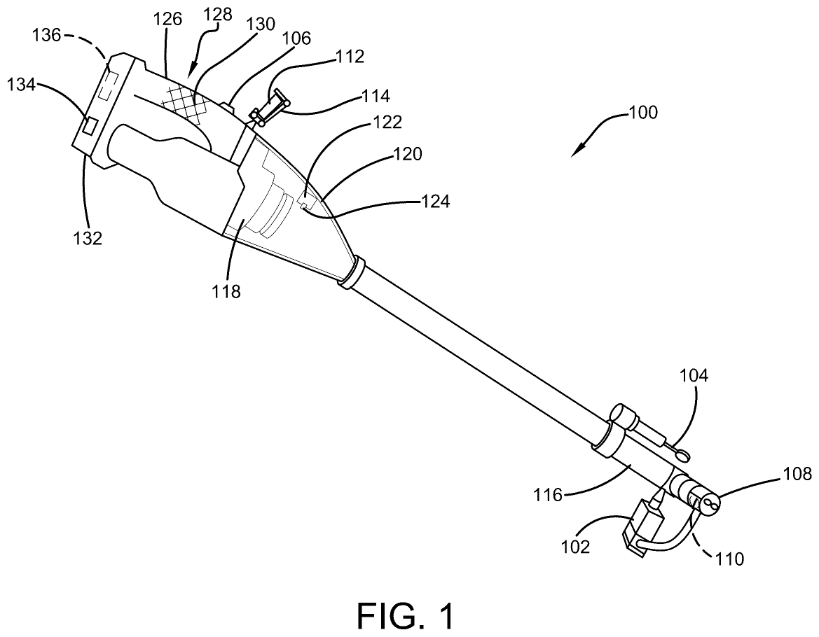

Referring initially to the drawings, FIG. 1 illustrates a perspective view of one potential embodiment of a saffron stem extractor device 100 of the present invention in accordance with the disclosed architecture. The device 100 is designed to efficiently sever and collect saffron stems directly from crocus flowers without detaching the flowers from their natural growing environment. More specifically, the device 100 may be comprised of several integrated components configured to perform cutting, viewing, suction, and collection functions in a coordinated and streamlined manner.

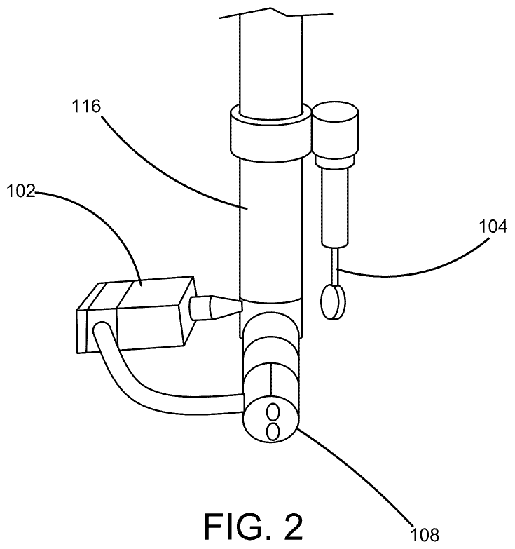

The device 100 may be comprised of a cutting mechanism 102 configured to sever one or more saffron stems from a crocus flower with precision and minimal disturbance. In one embodiment, the cutting mechanism 102 is comprised of a laser (as seen in FIG. 2) that emits a focused laser beam. The laser beam may be directed toward targeted saffron stems via at least one redirecting element 104 such as but not limited to a stationary mirror, a rotating mirror, a galvanometer-based scanner, a prism-based beam deflector, microelectromechanical (MEMS) mirror arrays, adaptive optical systems for beam steering, etc. The laser type of the mechanism 102 may be selected from various types such as but not limited to diode lasers, fiber lasers, CO₂ lasers, or solid-state lasers, based on the cutting precision, depth of penetration, beam quality, and thermal impact on surrounding plant tissue.

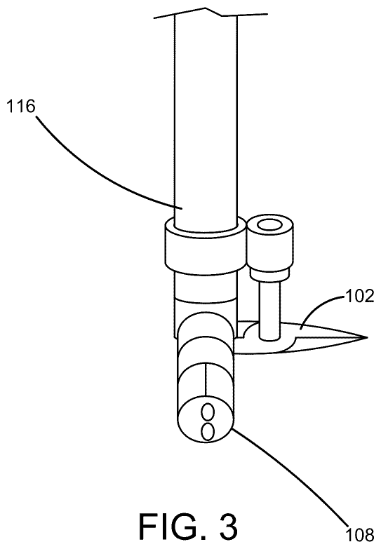

In an alternative and/or additional embodiment, the cutting mechanism 102 is comprised of at least one mechanically actuated cutting blade (as seen in FIG. 3) configured to achieve selective separation of the saffron stems from the flower. The blade may include but is not limited to a circular rotary blade, a string trimmer mechanism, a reciprocating or linear-actuated blade, a spring-actuated guillotine blade, a multi-point serrated blade, thermally assisted blades, micro-serrated precision shears, etc. The specific blade type and geometry of the mechanism 102 may be chosen based on factors such as the size and orientation of the saffron stigmas, desired cut characteristics, ease of sterilization, and resistance to biological material adhesion.

Activation and deactivation of the cutting mechanism 102 may be controlled by at least one user interface control 106 (as seen in FIG. 1) such as but not limited to a tactile push-button, a two-way toggle switch, a capacitive or resistive touch sensor, a voice-activated input system, etc. The device 100 may be further comprised of a viewing element 108 such as but not limited to any combination of (but not limited to) a digital microscope, an optical magnifier with variable zoom, a camera module with autofocus capability, or a combination of imaging sensors. Said viewing elements 108 may include image enhancement functionality features such as contrast adjustment, edge detection, or digital overlays to assist in accurate positioning and targeting of saffron stems relative to the cutting mechanism 102.

Captured images or video from the viewing element 108 may be transmitted wirelessly using a wireless communication module 110 such as but not limited to a Bluetooth module, a Wi-Fi transceiver, a near-field communication (NFC) module, or a proprietary low-energy RF protocol. The transmitted visual data may be displayed on a smart device 112 such as but not limited to a smartphone, a tablet, a wearable display, or an augmented reality (AR) heads-up display (HUD). This allows the operator to receive real-time imaging feedback to facilitate alignment and targeting of the stems. In one embodiment, the smart device 112 may be secured to using a mount 114 such as but not limited to a spring-loaded clamp, an articulated mechanical arm with multiple degrees of freedom, a magnetic docking base, or a telescoping adjustable cradle.

The device 100 may be further comprised of a vacuum tube 116 (as seen in FIG. 1) designed for partial insertion into the interior of the crocus flower to envelop and secure the saffron stem prior to cutting. The vacuum tube 116 may be made from a transparent and durable material such as but not limited to polycarbonate, acrylic, borosilicate glass, clear polymer composite, or UV-stabilized PET. A vacuum motor 118 such as but not limited to a brushed DC fan motor, a high-efficiency brushless centrifugal pump, a diaphragm-style micro vacuum pump, or a miniaturized turbine assembly may be integrated within the device 100 to generate negative pressure. Activation of the motor 118 may be automatically or manually synchronized with the cutting mechanism 102 to ensure seamless and timely extraction of severed saffron threads, wherein the severed threads may be transferred into a collection chamber 120 which may be comprised of a detachable or integrated receptacle. The chamber 120 may be fabricated from non-reactive, food-grade materials such as but not limited to stainless steel, polypropylene, polytetrafluoroethylene (PTFE), or medical-grade silicone. The chamber 120 may include a lid 122 such as but not limited to a snap-fit cap, a threaded screw-top cover, a flip-top hinged lid with gasket seal, or a clamshell closure. The lid 122 may incorporate a locking mechanism 124 such as but not limited to a twist-lock mechanism, a magnetic latch, a cam-lock actuator, or a quick-release latch to secure the harvested saffron stem material and prevent contamination or loss during handling and transport.

The device 100 may be further comprised of a handle 126 configured for ergonomic handheld use. The handle 126 may feature an anatomical contour and may include a grip area 128 made of non-slip materials such as but not limited to thermoplastic elastomer (TPE), soft-touch rubberized coating, or textured silicone overlays. The grip area 128 may further incorporate surface texture 130 such as but not limited to raised ridges, dimples, micro-patterned etching, or knurled designs to enhance tactile feedback and operator stability.

The device 100 may be powered by a battery 132 which may be selected from chemistries such as but not limited to lithium-ion, lithium-polymer, nickel-metal hydride (NiMH), or alkaline formats. The battery 132 may be modular and replaceable and may be rechargeable via a charging port 134 such as but not limited to a USB-C connector, a micro-USB port, a magnetic pogo-pin interface, or an inductive wireless charging module. To ensure consistent energy management, a power management circuit 136 may be included having functionality for voltage regulation, overcurrent protection, short-circuit detection, battery level monitoring, and thermal cutoff to safeguard internal components and extend battery 132 life.

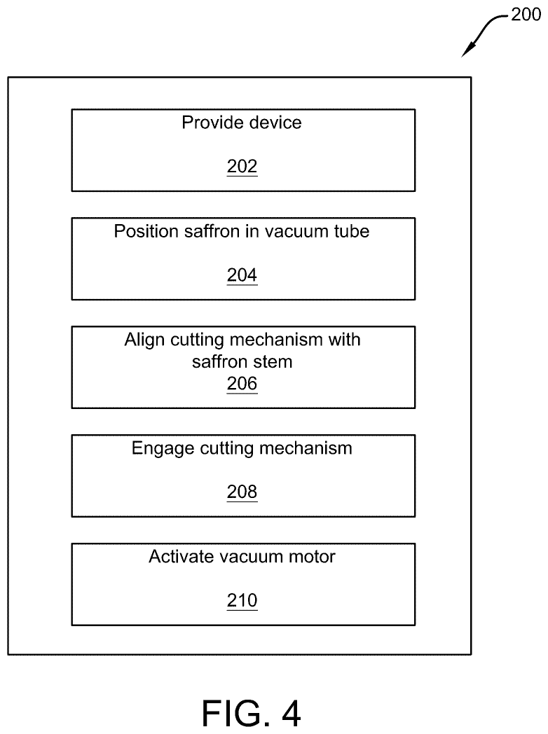

The present invention is also comprised of a method of using 200 the device 100, as seen in FIG. 4. First, a device 100 is provided comprised of a cutting mechanism 102, at least one redirecting element 104, a user interface control 106, a viewing element 108, a wireless communication module 110, a smart device 112 mounted via a mount 114, a vacuum tube 116, a vacuum motor 118, a collection chamber 120 with a lid 122 and locking mechanism 124, a handle 126 with a grip area 128 and surface texture 130, a battery 132, a charging port 134, and a power management circuit 136 [Step 202]. Then, the device 100 is grasped by the handle 126 so that the vacuum tube 116 can be inserted into the crocus flower to position and secure a saffron stem within the tube 116 [Step 204]. Next, the viewing element 108 is used to visually align the cutting mechanism 102 with the target saffron stem while real-time imagery is displayed via the smart device 112 connected through the wireless communication module 110 [Step 206]. Then, the user interface control 106 is activated to engage the cutting mechanism 102 to sever the saffron stem, wherein the redirecting element 104 guides the laser beam or the blade mechanism toward the targeted region [Step 208]. Next, the vacuum motor 118 is activated either automatically or manually to generate negative pressure through the vacuum tube 116, thereby extracting the severed saffron stem into the collection chamber 120 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “saffron stem extractor device” and “device” are interchangeable and refer to the saffron stem extractor device 100 of the present invention.

Notwithstanding the foregoing, the saffron stem extractor device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the saffron stem extractor device 100 as shown in the FIGS. are for illustrative purposes only, and that many other sizes and shapes of the saffron stem extractor device 100 are well within the scope of the present disclosure. Although the dimensions of the saffron stem extractor device 100 are important design parameters for user convenience, the saffron stem extractor device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A saffron stem extractor device comprising:
a cutting mechanism having a laser;
a redirecting element configured to direct a beam of the laser;
a vacuum tube;
a viewing element;
a wireless communication module;
a battery;
a vacuum motor; and
a collection chamber comprised of a lid.

2. The saffron stem extractor device of claim 1, wherein the redirecting element is comprised of a stationary mirror, a rotating mirror, a galvanometer-based scanner, a prism-based beam deflector, and a MEMS mirror array.

3. The saffron stem extractor device of claim 1, wherein the viewing element is comprised of a digital microscope.

4. The saffron stem extractor device of claim 1, wherein the viewing element is comprised of a camera.

5. The saffron stem extractor device of claim 1, wherein the laser is comprised of a diode laser, a fiber laser, a CO₂ laser, or a solid-state laser.

6. The saffron stem extractor device of claim 1 further comprised of a mount for securing a smart device.

7. The saffron stem extractor device of claim 6, wherein the mount is comprised of a spring-loaded clamp, an articulated mechanical arm, a magnetic docking base, or a telescoping adjustable cradle.

8. The saffron stem extractor device of claim 1, wherein the vacuum tube is comprised of a transparent vacuum tube.

9. The saffron stem extractor device of claim 1 further comprised of a handle.

10. A saffron stem extractor device comprising:
a cutting mechanism comprising a blade;
a vacuum tube;
a viewing element;
a wireless communication module;
a battery;
a vacuum motor; and
a collection chamber comprised of a lid.

11. The saffron stem extractor device of claim 10, wherein the blade is comprised of a circular rotary blade, a string trimmer mechanism, a reciprocating or a linear-actuated blade, a spring-actuated guillotine blade, a multi-point serrated blade, a thermally assisted blade, or a micro-serrated precision shear.

12. The saffron stem extractor device of claim 10, wherein the viewing element is comprised of a digital microscope.

13. The saffron stem extractor device of claim 10, wherein the viewing element is comprised of a camera.

14. The saffron stem extractor device of claim 10, wherein the laser is comprised of a diode laser, a fiber laser, a CO₂ laser, or a solid-state laser.

15. The saffron stem extractor device of claim 10 further comprised of a mount for securing a smart device.

16. The saffron stem extractor device of claim 15, wherein the mount is comprised of a spring-loaded clamp, an articulated mechanical arm, a magnetic docking base, or a telescoping adjustable cradle.

17. The saffron stem extractor device of claim 10, wherein the vacuum tube is comprised of a transparent vacuum tube.

18. The saffron stem extractor device of claim 10 further comprised of a handle.

19. The saffron stem extractor device of claim 10 further comprised of a charging port.

20. A method of using a saffron stem extractor device, the method comprising the following steps:
providing a saffron stem extractor device comprised of a cutting mechanism, a user interface control, a viewing element, a wireless communication module, a smart device, a vacuum tube, a handle, a vacuum motor, and a collection chamber;
grasping the saffron stem extractor device by the handle and inserting the vacuum tube into a crocus flower to secure a saffron stem;
using the viewing element to align the cutting mechanism with the saffron stem while displaying a real-time imagery via the smart device;
activating the user interface control to engage the cutting mechanism; and
activating the vacuum motor to generate negative pressure to extract a severed saffron stem into the collection chamber.
